(19) United States
(12) Patent Application Publication
(10) Pub. No.: US 2009/0029685 A1
(43) Pub. Date: Jan. 29, 2009

(54) SYSTEM AND METHOD FOR RINGTONE GENERATION

(75) Inventor: Michael John Willis, Deerfield Beach, FL (US)

Correspondence Address: FOLEY & LARDNER LLP, 111 HUNTINGTON AVENUE, 26TH FLOOR, BOSTON, MA, 02199-7610, US

(73) Assignee: MVISIBLE TECHNOLOGIES, INC

(21) Appl. No.: 11/994,366

(22) PCT Filed: Jul. 3, 2006
(86) PCT No.: PCT/US06/26066

§ 371 Date: Aug. 7, 2008

Related U.S. Application Data
(60) Provisional application No. 60/758,879, filed on Jan. 13, 2006.
(60) Provisional application No. 60/696,395, filed on Jul. 1, 2005.

(51) Int. Cl. H04W 88/00

(52) U.S. Cl. 455/414.1

(57) ABSTRACT

The present invention relates to mobile communications and, in particular provides a system that allows for the creation of content for such uses as ringtones for mobile phones, and systems for deploying such content, i.e., segmenting and transferring media files to a mobile communication device.

### FIELD OF THE INVENTION

The present invention relates to mobile communications and, in particular provides a system that allows for the creation of content for such uses as ringtones for mobile phones, and systems for deploying such content, i.e. segmenting and transferring media files to a mobile communication device.

### BACKGROUND

In view of the explosive growth in the use of wireless telecommunication devices, users increasingly desire to transfer data files to their devices, such as to personalize the operation of the devices. One example is in the area of mobile telephones, where users are personalizing their phones by loading media files, such as graphic and sound files onto their phones. For example, there is a growing trend for mobile phone users to use personalized ringtones when they receive a phone call rather than the default ringtone that is equipped on the phone. However, the process for loading a ringtone onto a user's phone can be tedious and expensive. Typically, the user will go through his or her mobile phone service provider to obtain new ringtones. Consequently, the user is limited to the particular ringtones offered by the mobile service provider. In addition, the user must typically pay a monthly service fee in addition to a download fee for each ringtone in order to obtain ringtones from the mobile service provider.

### SUMMARY OF THE INVENTION

The present invention provides a system for and method of distributing content from a first network device to a second network device. The system accesses media content in a first media format; obtains configuration information regarding the second network device, where at least a portion of the configuration information descriptive of at least one media format is compatible with the second network device; identifies a second media format compatible with the second network device; converts the content from the first media format to the second media format to form a converted media content; instructs a third network device to send a message to the second network device, the message configured to cause the second network device to establish a communication link with the first network device; upon establishment of the communication link between the first and second network devices, transfers the converted media content in the second format to the second network device. The content is created from source audio files that are supplied by users and the system dynamically chooses appropriate segments of the audio files to use as ringtones, and the format appropriate for the target second network device.

In another aspect, the invention provides a computer program on computer readable medium that includes instructions to cause a computer to: access media content in a first media format; obtain configuration information regarding the second network device, at least a portion of the configuration information descriptive of at least one media format compatible with the second network device; identify a second media format compatible with the second network device; convert the media content from the first media format to the second media format to form a converted media content; instruct a third network device to send a message to the second network device, the message configured to cause the second network device to establish a communication link with the first network device; upon establishment of the communication link between the first and second network devices, transfer the converted media content in the second format to the second network device. The computer system includes instructions for dynamically creating song segments to use as ringtones from source audio files that are supplied by users, and the ringtone audio format appropriate for the target second network device.

In another aspect, the ringtone generation system includes: a server having a WAP interface, a HTML interface and a Web service interface; a database; and one or more media processor components, wherein the system processes audio content input by a user through the media processor to produce an audio file suitable for use as a cellular telephone ringtone.

In another aspect, the invention provides a method of generating a mobile telephone ringtone, including the steps of: obtaining a computer readable audio file; processing it into a second audio file using the system described, wherein the second audio file can be processed and played by a mobile telephone; and downloading the second audio file to the mobile telephone; and configuring the mobile telephone to play the second audio file as a ringtone.

In another aspect, the invention provides a method of processing an audio file, including the steps of: obtaining a computer readable audio file; selecting a time interval in the audio file corresponding to a segment of music or voice or both, and processing the audio file into a second audio file that is readable by a mobile telephone and can be configured as a ringtone. The systems and methods described include computer readable code that modifies a web page to make all of the web-based content referenced by the webpage available for immediate delivery to a mobile phone, and may further include computer readable code that enables arbitrary internet-hosted media to be located, processed and delivered to mobile phones.

In yet another aspect, the invention provides a method of editing a media file, including the steps of: identifying the content of the media file; prompting a first user to select at least one desired portion of the media file; storing data associated with the at least one desired portion of the media file; receiving an inquiry from a second user to obtain an edited version of the media file; and preparing an edited version of the media file for the second user by the use of the data associated with the at least one desired portion of the media file. In one embodiment, the method includes obtaining information from the second user regarding a desired format of the edited version of the media file. In another embodiment, the information from the second user regarding a desired format includes details of a mobile phone. In another embodiment, the method verifies ownership rights of the second user in at least a copy of the media file. This may include the second user transmitting the copy of the media file or verifying the second user has purchased a copy of the media file. In various embodiments, the content of the media file is a song, and particularly a ringtone. In other various embodiments, the edited version of the media file is transferred to a mobile phone. In various cases, the method includes before the act of transmitting, the step of receiving a message from the mobile phone. In one embodiment, transmitting is accomplished at least partially by the use of Wireless Application Protocol (WAP). In another embodiment, the act of identifying an appropriate ringtone segment involves the use of metadata unique to the content of the media file. In another embodiment, preparing the ringtone includes reformatting the edited version of the media file to be able to play as a ringtone on a phone. In certain embodiments, receiving an inquiry from a user involves the user entering the request via a web browser. The web browser may be hosted on a personal computer and the request may include a phone number of a second user. The second user may be prompted by the system, i.e., wherein the act of prompting includes gathering information concerning portions of the media file not desired by the first user, or wherein, in the act of prompting, a plurality of users are prompted to select at least one desired portion of the media file and, in the act of preparing, the edited version of the media file is representative of the desired portion of the media file as selected by a majority of the plurality of users.

In another aspect, the invention provides a medium holding electronic device executable steps for a method, the method comprising: identifying the content of the media file by the use of metadata corresponding to the content of the media file; prompting a first user to select at least one desired portion of the media file; storing data associated with the at least one desired portion of the media file; receiving an inquiry from a second user to obtain an edited version of the media file; and preparing an edited version of the media file for the second user by the use of the data associated with the at least one desired portion of the media file, including reformatting the edited version of the media file to be able to play as a ringtone on a phone.

In another aspect, the invention provides a method of editing a media file, comprising: receiving an inquiry from a first user to obtain an edited version of the media file for use as a ringtone on a phone; preparing a first proposed edited version of the media file by the use of beat-slicing to infer the tempo of a rhythm-based song to determine at least one first desired portion of the media file, the first proposed edited version of the media file including the at least one first desired portion; preparing a second proposed edited version of the media file by the use of beat-slicing to infer the tempo of a rhythm-based song to determine at least one second desired portion of the media file, the second proposed edited version of the media file including the at least one second desired portion, the at least one first desired portion of the media file being different from the least one second desired portion of the media file; receiving a preference from the first user between the first proposed edited version and the second proposed edited version; storing the preference from the first user; presenting the preference from the first user to a second user that submits an inquiry to obtain an edited version of the media file for use as a ringtone on a phone. In certain embodiments, the act of receiving an inquiry involves at least one of the group of: an SMS message, a WAP Push message, and an MMS message.

In another aspect, the invention provides a system for editing a media file, the system comprising: a server adapted to store at least one media file and receive preference information concerning at least one desired portion of the media file from a plurality of first users to create an edited version of the media file and receive an inquiry from a second user to obtain an edited version of the media file for use as a ringtone, the inquiry including information regarding the phone on which the ringtone will be used; and a mobile phone in communication with the server to receive the edited version of the media file and audibly play the edited version of the media file upon receiving a call. In various embodiments, the server is in communication with the mobile phone at least partially by the use of a WAP interface

Other such variations of the invention will be appreciable by those of skill in the relevant art. Such variations are intended to be included in the scope of the claims that follow.

### DETAILED DESCRIPTION

The present invention is a system that allows for the creation and deployment of audio content, video content, pictures, wallpaper, and other types of content for use with mobile phones. In a particularly preferred embodiment, the content is audio content (or video content with sound) that can be processed into segments that are usable as ringtones. Ringtones are first created by extracting segments from source audio or video files. In one embodiment, these files are supplied by end users or content owners. In another embodiment, these audio or video files are provided by a third party, preferably an authorized third party such as a band that wants to provide songs to fans, and such files are supplied for example, over a network. Regardless of source, the invention dynamically processes content into segments, and converts those segments into a format suitable for use with a mobile phone.

Ringtones are deployed to mobile phones using a combination of mobile messaging, such as SMS and MMS, and internet technologies such as WAP. See for example, United States Patent Application 20060015649 (incorporated herein by reference in its entirety), which describes a system that permits a user to customize and distribute the media content over a network from a first network device, such as a personal computer, to a second network device, such as a mobile phone. Prior to distributing the media content, the user can use the first network device to easily and automatically convert the media content from a first format to a second format that is recognizable and usable by the mobile device. The user can easily and quickly access a media file and convert the entire file, or a portion thereof, to the second format.

The invention, referred to as Myxer™ herein, is different from traditional ringtone generation and distribution systems in several ways. With Myxer, ringtones can be custom created from source audio files, i.e., those that are supplied by users, instead of relying on a centralized catalog of available titles. Myxer can dynamically choose appropriate segments of sound files to use as ringtones, and dynamically converts the audio into a format appropriate for the target device. Myxer is independent of the mobile operator used to provide cellular service to the user, and it requires no changes to carriers' networks.

While a currently preferred embodiment of this system, as described more fully herein, focuses mainly on the task of talking source audio files and converting them as appropriate for use as ringtones, the system of the invention has also been architected to support many different media formats using similar basic algorithms and techniques. For example, videos, and full-track audio content can be processed by the system into ringtones, and video and still images can be processed into wallpaper. Thus, the creation and delivery of a ringtone is not intended to be limited to audio, and the original source of the resultant content need not be audio file.

System Requirements

There are various components that make up the Myxer system, and they run in multiple environments. It is not intended that the invention be physically located on one discrete computer system, rather the various component parts are capable of being networked, i.e., via a packet switched network. In fact, in various embodiments it is preferable that the individual components be networked, to provide a complete system for ordering, processing and delivering content to mobile phones. Preferably the server-side components run in a traditional internet data center on common server hardware and operating systems. The ‘clients’ of the Myxer system are mobile devices. Myxer does not currently require any special software to be installed on the mobile device, but it requires that the device be an internet-enabled mobile phone capable of using waveform-based audio as ringtones.

Explicit support for the major US carriers exists (Cingular, Verizon, T-Mobile, and Sprint/Nextel), but many other smaller and regional carriers are supported without special code because the system relies mainly on standard internet and mobile phone technologies for delivery.

An optional component of the system is the MyxerTones Desktop Agent™, also called the Media Center Agent™. This is a component that is installed by an end-user on their broadband-connected computer running an appropriate operating system, preferably such as Windows XP or later, but also LINUX, UNIX, Mac OS-X, and other common operating systems.

The system can process input files in various standard audio formats, including MP3, WMA, M4A (AAC), WAV, and many others. It can generate output audio in common formats including MP3, WMA, M4A (AAC), QCP, AMR, AWB, SMF, and others. As other audio file standards are developed, the system is dynamic and may be modified to support these new standards.

Source audio files can be obtained from a user's personal computer or media center. These files are usually uploaded to Myxer before being converted into ringtones. Files may be uploaded using a desktop web browser and the Myxer web site using traditional internet upload mechanisms. Optionally, the Myxer Media Center Agent may be installed on the user's personal computer to facilitate remote access to song files on the computer. Using the Media Center Agent, source audio files may be uploaded from the user's personal computer to Myxer using a mobile phone.

System Architecture

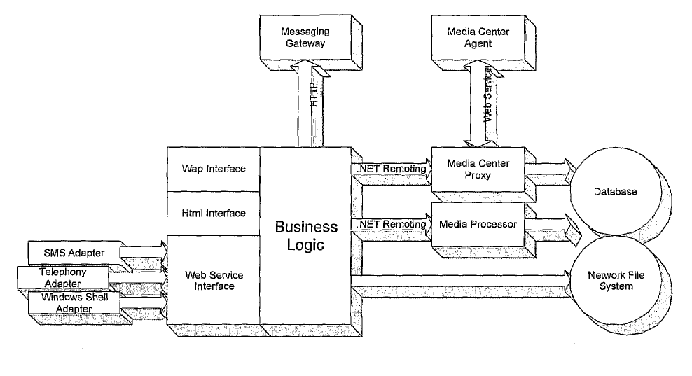

The overall architecture of the Myxer system is given by the diagram in FIG. 1. Most of the system components are hosted by a web server, and run as a traditional web application. The primary entry points to the system include: a WAP interface for access from mobile phones, an HTML interface for access from desktop browsers, and a web service interface for access from alternative user interfaces such as a native Windows interface, an SMS adapter interface, a telephony adapter interface, or a third-party (“affiliate”) website that offers Myxer functionality. Security is performed at this entry point.

The Wap/Web/Web Service interface uses Business Logic in the form of a set of business objects, also hosted on the web server, to provide core functionality to users. The business logic makes use of a database containing user information, segment records, information about file uploads, information about various device capabilities, information about WAP gateways used by cellular providers, logging and auditing capabilities, ecommerce data structures, and so forth. One or more Media Processor components may be hosted on the same machine, or on one or more remote machines within the web server's network. The media processor component is responsible for uploading files from users, extracting information from them (such as the song they contain, the artist and album from which the song came, etc.), and converting them from one file format to another. Multiple instances of this media processor component may be needed in large deployments, because the translation and upload jobs can be CPU and network intensive.

A Media Center Agent™ (a.k.a. “MyxerTones Desktop Agent™” or “Myxer Desktop Agent™” or “Desktop Agent™”) component may or may not be present on a user's home computer, for example a PC. This component is responsible for making information about the user's media library available to the Myxer service, and for making files available when requested by the user. The media center agent is implemented as a small executable that runs on the home PC.

The media center proxy represents the user's home media center for the benefit of other server-side Myxer components. There may be multiple instances of this component in large installations, because each subscriber may potentially have a Myxer agent running on their media center, and this agent will be constantly making requests of the media center proxy. A farm of media center proxies can therefore be implemented and the load shared with traditional load balancing techniques to avoid scalability bottlenecks.

Because the system deals with many large files, a shared network file system is used for storage by many Myxer components. This approach scales better than putting all of the required files in a relational database. More storage can be put online at any time, and support from a filesystem such as DFS allows for flexibility in where the data actually lives. Additionally, hierarchical storage, whereby seldom-used or old files are backed up to cheaper storage without requiring the files path to change, can be easily implemented.

When a Myxer component wants to send a message to a user or to a user's phone, it makes use of the services of the Messaging Gateway. This gateway may be a GPRS modem attached to the serial port of a computer on the web server network, it may be an external SMS gateway such as Clickatell, CSoft, or m-Qube that serves as an SMS aggregator for delivering messages to phones on behalf of Myxer, it could use a dedicated connection to a carriers messaging infrastructure, or it could send an email to the user on their phone. In any case, the interface to this component is via HTTP, either with a simple HTML forms based interface or a web service interface.

Web Interface

The web interface currently preferred is built using Microsoft's ASP.NET, and runs on Internet Information Service. This is a simple implementation choice, and the system could just as easily be built using other technologies such as Java Server Pages (JSP) running on a web server such as Apache. Some pages on the site are unauthenticated, and may be accessed by anyone that knows the URL. Other pages may be accessed only by authenticated users. While authentication is currently performed using a modified version of ASP.NET's Forms Authentication, there are many other common mechanisms for enforcing authentication know to those of skill in the art, and these can be adapted for Myxer.

Authentication

Authentication requirements are specified in various configuration files maintained as a part of the web application. The current implementation has a default setting of “requires authentication” for all pages, with those pages that do not require authentication being specified explicitly in an appropriate configuration files (such as web.config).

Users are authenticated when they supply a valid username and password. These credentials are checked against a database. If a user supplies valid credentials, a transient cookie is returned to their web browser which allows the web site to recognize them as an authenticated user for a configurable time period.

Base Class for Web Pages

There is also a base web page from which all Myxer web pages should derive. This class, BaseHtmlWebPage, has a Page_Load handler that insures that all of the MyxerSession state (that is, session state that is relied on for use by various Myxer components) is set up appropriately before letting the page execute. This base class is necessary because it is possible for a user's session to expire while their authentication remains valid. Thus, it is not sufficient to simply build the MyxerSession state upon login.

Header and Footer Controls

Each web page uses the header and footer web user controls to display a uniform header bar and footer bar. The header control displays different menu options to the user depending on whether or not they are authenticated. Authenticated users can do about anything, unauthenticated users are restricted.

Myxer Session State

The base html web page also supplies a set of variables that can be used by any page. These variables are contained in the MyxerSessionState object, which is available as the ‘MyxerSession’ property of the base web page. The Myxer session state contains things like the preferred ringtone format for a user, the user name, and so forth.

Wap Interface

The wap interface provides access to functionality from the mobile phone. The Wap site is built using ASP.NET mobile controls, which may or may not turn out to be a good idea. Though called the “WAP” interface throughout this document, the WAP interface may in actuality be rendered to a target device as WAP1.x, WAP2.x, XHTML, HTML, or another markup language as appropriate for the device. We use the term “WAP” because that is a lower common denominator of device support, and it implies a simpler interface than the rich HTML supplied by the web interface.

The design of the WAP site is similar to that of a (very) stripped-down version of the HTML site. There is a different base class for WAP pages (BaseMobileWebPage) that provides similar functionality to the base page for HTML. Specifically, each derived mobile page can always assume that the user is authenticated and the session state is valid.

The WAP site may be accessed in one of two different modes. First, a user can navigate directly to the WAP site (www.myxertones.com/wap), at which point they are prompted for username and PIN. Upon logging on, they are presented with a simple list of possible actions. Users that have the media center agent installed and running on their home PC can browse and search their home media center for songs. Users may also view a list of recently-created ringtones. In this mode, the WAP site functions as a mini-version of the web site.

In addition to navigating the WAP site like a web page, users may be directed to the site by an SMS messages sent by the Myxer service with a link to a particular ringtone. In this case, the URL requested by the phone is something like “/downloads.aspx?r=5355&u=19542942294”. When a user hits a link for a ringtone, it allows them to retrieve the ringtone without logging in. This makes the process of getting a ringtone work a lot more smoothly than when the user has to log in.

The downloads.aspx page looks up the ringtone whose ID is given, validates that it was created for the phone number given, and provides a link to the user from which the ringtone can be retrieved directly. Ideally, the user is redirected directly to the ringtone file.

Preventing Multiple Users from Accessing the Same Ringtone.

When Myxer prepares content (ringtones) for users, it provides the user with a URL with which they can access (download) the content, as described above. Because the system doesn't use traditional authentication on the download.aspx page for usability reasons, it needs some other way to make sure the same download is not accessed by other users.

To download a file, a user typically passes first through code associated with the download.aspx page. Before honoring a download request, this code first checks the database for the ringtone record associated with the requested ringtone. The ringtone record has a column that identifies the user that owns the ringtone, as well as a checksum value that is built to be unique to the device used by the owning user. If either (a) the user parameter supplied does not match the owning user specified in the ringtone record, or (b) the checksum calculated for the requesting device does not match the checksum for the user's device, the download is not permitted.

In currently preferred embodiments, the checksum for the user's device is calculated based entirely on the user-agent string associated with the device. Because the user-agent string is not unique to a particular device (it is unique to a particular type of device, such as “Motorola V600 phone”), this checksum generation is not foolproof. However, there are normally other pieces of information included with a mobile download request that can be used to uniquely identify a particular phone. This information is provided in server request variables, such as “Subscriber-ID”. The subscriber ID information is provided to allow portals to personalize their appearance for a particular user, but they could be used for security as described here.

Essentially, the system is locking the download such that it can only be accessed by the user's device, without requiring the user to enter their credentials before accessing the download. This is a tremendous usability improvement, as entering data on a mobile phone keypad can be difficult and error prone. In addition, it is faster. This same technique is applicable to downloads of any kind.

Web Service Interface

All other user interfaces are typically built using the web service interface. This currently includes only the media center agent, which exposes some functionality from the user's PC.

Note that there are actually two web service interfaces that currently exist as part of the Myxer system. The main web service interface provides functionality similar to that provided by the WEB and WAP pages; namely access to user-specific information and functionality. The ‘media center interface’, currently implemented as host.asmx in the project, provides the interface used by the media center agent to request work items (and to report their completion).

SMS Gateway (Inbound)

In addition to using the web or wap sites to access myxer functionality, users may also send SMS messages to the Myxer service for some functionality. Myxer has registered the SMS Shortcode 69937 (“MYXER” on the phone keypad) in the United States, which allows any mobile phone user to send a text message to the company using that shortcode.

Users can text “MYXER” in order to: search for a song on their home media center, send a link to Myxer to another number (invite a friend), request a particular piece of content identified by name or ID, send a message to (an) other Myxer user(s), adjust account settings, or any of a number of other tasks.

Requesting a Particular Piece of Content

Content owners can prepare content to be delivered using Myxer services. This is done by first supplying either (a) an upload of the source file or (b) a link to the source file (such as an HTTP URL), and then associating a unique identifier with the content. The unique identifier may be generated by Myxer automatically, or it may be supplied by the content owner. Once a piece of content has been prepared in this manner, a database record is created to maintain the mapping between identifier and content (or link to content).

When content is registered in this manner, it may be made available to Myxer users. One way users can request the content is to send the unique identifier of the content to the Myxer shortcode. When this happens, Myxer searches the database for the associated content record, fetches the associated content, and then prepares and delivers it to the user using the mechanisms already described. This type of delivery allows content owners to distribute their content easily without requiring the users that receive the content to go to a web browser. For example, a local band might prepare a song with Myxer and give it the unique identifier “Next Time”. Then, at a live show, they could tell the audience members to text the message “Next Time” to the Myxer short code (“69937”) to receive the song (or ringtone).

Searching Home Media Library

Searching the home media library is done by texting the search string to the Myxer SMS phone number. Upon receiving the message, the SMS gateway uses the web service interface to log the user on, request the search, and build a response SMS that is sent to the user.

There are three possible results from a search via SMS. First, the search string might match exactly one song. In that case, a ringtone will be prepared for the song, and the user will be sent a message with a link to the ringtone. Second, the search might fail, either because no match was found, or the host agent was not available. In that case, a failure error message is sent to the user's phone. Finally, the search may result in multiple results. In this case, the user is sent a message with a link to the WAP site's search page so that the user can choose from the results.

Subscribing/Unsubscribing from a Fan List

Content owners may also set up groups called ‘fan lists’. When a user signs up for a ‘fan list’, they may be sent messages and content from the associated content owners. Control over fan lists membership can be effected by sending the appropriate code to the Myxer shortcode.

Media Center Agent/Media Center Proxy

A user's media library may include songs, videos, animations, images, audio clips, or other media. The library may reside completely on the home PC, or may be spread between the PC and various other devices such as PDAs, portable music players such as iPods or another “mp3 player”, portable game devices such as PlayStation Portable, dedicated digital video recorders such as the TiVo, external media centers such as the Windows Media Center, digital cameras, and various other devices. Regardless of the location of the media and media library, the media center agent collects information about available media and provides access to it.

This component actively communicates with Myxer by way of the Media Center Proxy's exposed web service interface. It constantly asks if there are any work items for it to process. The reason the media center agent uses the media center proxy's web service interface, and not vice-versa, is to deal with firewall issues on the agent's computer. Generally, a user will have their home PC behind a firewall that will prevent incoming connections. By implementing a protocol in which the agent uses a firewall-friendly interface (web services over HTTP) to request work to do, we can be virtually assured that the agent will be able to communicate with the media center proxy.

Integration with Existing Desktop Search Engines

There are many third party search engines that may be installed on a home PC. For example, Google has the “Google Desktop Agent” that allows a user to search the contents of their home PC using an interface similar to the Google search engine for the web. Similar search engine tools are provided by Microsoft and Yahoo! All of these tools are intended to be used locally on the PC on which they are installed.

The media center agent can use extensibility mechanisms provided by these search vendors to provide better search capabilities than the default directly searching built into it. The media center agent accepts work items from the media center proxy running in the data center, which itself communicates with the user's mobile phone using the WAP or SMS interface. By interfacing with the local search product, the media center agent effectively remotes the search capabilities of the search product to the mobile phone without any changes to the search product itself. By supplying the appropriate options to the search product, the search can be restricted to media files supported by Myxer.

This setup provides a powerful way for users to move content from their home media center to their mobile phone. First, they communicate a request to Myxer using the WAP interface or the SMS interface. Myxer uses the media center proxy to forward the request to the media center agent running on the users home PC. The media center agent uses the services of a local search engine, such as Google Desktop Search, to locate appropriate media files. The media center agent then uploads the file to the media processor, which processes the file as appropriate and delivers it to the user's mobile phone. The content may be delivered directly over an existing WAP interface (i.e., by providing a WAP page that contains a hyperlink that will download the file), or by delivering a new SMS message to the requesting phone. (It could also simply be stored on the server for later download by the phone).

This search and download capability is very powerful, and can be applied to many different media formats. For example, a user may have a large library of digital images on their home PC. Using the technique described above, a user could browse and search these images for a particular set of images, and have them delivered on demand to their mobile phone. Because the mobile phone will typically have orders of magnitude less storage than a home PC, it will not generally be able to hold all of the digital images that can be held on the home PC. Using this mechanism provides a great way to give the mobile phone access to all of the contents of the home media center.

Scheduled Content Deliveries

Users may periodically wish to update their phone's wallpaper, ringtone, or audio files with other content that exists in their home media center. Instead of always having to actively request a particular piece of content to download to their mobile phone, users can set up scheduled delivers of content. For example, they can specify a folder on their home PC called “Songs For Ringtones.” They can then provide this folder as a configuration setting to the media center agent, along with settings as to how often to deliver a new ringtone to the phone. At the appropriate time, the media center agent can pick a song from that folder according to any of a number of algorithms, and send that song to the media center proxy running in the data center. The Myxer business logic can then send an SMS message to the user with a link to download the new content. In this way, the user is provided with fresh content on their mobile phone without having to actively specify the content.

In another embodiment, the logic for scheduled deliveries may also be implemented completely in the business logic running in the data center. For example, the user could use the WEB interface to specify settings for what kind of content, from which locations, they would like to have automatically delivered to their phone. In this embodiment, the user may specify not just content that lives on their home media center, but also content that lives in other network accessible locations, such as an online photo management site.

Media Processor

One or more Media Processor components may be hosted on the same machine, or on one or more remote machines within the web server's network. The media processor component is responsible for uploading files from users, extracting information from them (such as the song they contain, the artist and album from which the song came, etc.), and converting them from one file format to another. Multiple instances of this media processor component may be needed in large deployments, because the translation and upload jobs can be CPU and network intensive.

Identifying Audio Files

One of the jobs of the media processor is to identify the artist, title, album, and other identifying information for files entered into the system.

One of the advantages of Myxer is that it uses its user population to add value to the system. One way it does this is by collecting little bits of information that each user contributes, such as what segment makes a good ringtone for a given song, and organizing it in such a manner as to bring value to other users. Because the actual source data going into the system often comes from an external source, the system benefits from being able to take an arbitrary piece of media content and assigning a canonical label to it that is the same label as would be applied to the same content uploaded by a different user from a potentially different original source.

For example, suppose a user has a legally-obtained copy of the song “American Idiot” by Green Day that they obtained by capturing (i.e., “ripping”) the track from a CD they purchased. Then suppose another user purchases the same song in digital form from an online store such as WalMart. Each of these users may upload the song independently to Myxer, but it is beneficial for Myxer to be able to assign both of the media files an identical label so that information we learn about one (such as what part of the song makes a good ringtone) can be applied to the other.

There are three basic approaches that are taken to get information about an uploaded file (and subsequently assign a canonical label).

Metadata.

Many audio formats, such as MP3, provide information about their contents in the form of metadata information included in the file's data. In the case of MP3 files, this information may be encoded with a format known as IDv3. When this metadata is present, the media processor simply reads it out of the file and uses it to associate the file with a song record from the database.

Fingerprinting.

Various algorithms exist for automatically identifying songs by creating an audio ‘fingerprint’. Companies such as 411song (NMK, Inc., New York: http://www.411song.com/) and Gracenote (Gracenote, Inc., Emeryville, Calif., http://www.gracenote.com) provide web-based services for uniquely identifying songs based on, for example, 15 seconds of audio. These services generally employ algorithms that identify discrete sonic patterns, i.e., instrumentation patterns such as kick drums or guitar, or vocal segments.

User Specification.

If no metadata is found in a media file, and fingerprinting cannot identify the file uniquely, the end user may specify the information themselves using a web interface.

Applicability to Other Media Formats

While Myxer is today primarily concerned with identifying song (music) files, the identification process is equally important for formats such as images and videos such as television, movie, animation, and music video clips. In each of these cases, the same three techniques (metadata, fingerprinting, user specification) may be used to identify the media.

Splicing and Processing of Audio Files

The media processor is responsible for splicing and converting media files. The media processor consists of various command-line conversion utilities that move audio from one format to another.

Processing audio files to turn them into ringtones is done logically as a three step process. First, the source audio file is converted to WAV format as a lingua franca for the rest of the process. Next, the section of the song to use as a ringtone is spliced out into a standalone WAV file. For example, a user specifies the temporal parameters of a song to specify the appropriate segment to be spliced from the song. Alternatively, Myxer can elect a segment based on patterns, e.g., a time slice of the song that encompasses an instrumental break such as a bridge. In various embodiments, Myxer elects the song segment based on user defined rules, such as “exclude vocals” using the above example. These first two conversion and processing steps are actually performed with a single invocation of the cliptowav.exe executable. Finally, the WAV file containing the ringtone section of the song is converted into the appropriate format. This last step is not done until the ringtone is actually requested by the user, because Myxer optimally will choose the output format based on the device that requests the ringtone.

Depending on which format is appropriate, one of several different encoder applications is used to convert the WAV file to the destination format. Among other conversion programs, Myxer uses lame.exe for building MP3's, a Nokia utility for building AMR/AWB's (such as Nokia Multimedia Converter 2.0), a Yamaha utility for building SMAF's, a third-party encoder for M4A's (such as ImTOO Audio Encoder v2.0: http://www.imtoo.com), and so forth. Each of these applications is spawned as an external process, and these file conversion programs are available as shareware or freeware from the above vendors. Many other equivalent programs are commonly available and obtainable through the Internet.

Database: The database tables are access directly only by code in the MyxerData assembly, which serves as a Database Access Layer for the rest of the system.

User Accounts

A Myxer user account may be either a trial account or a registered account. A trial account is created indirectly when a user takes advantage of the ‘free trial’ functionality provided by the landing page. A registered account is created, when a user provides payment which is confirmed. Both types of accounts are represented by an instance of a UserRecord object in the database.

Trial Accounts

Trial accounts are implicitly created by the system the first time a user either (a) sends a ringtone to their mobile phone via the free trial page, (b) signs up for the opt-in email newsletter from the free trial page, or (c) signs up to post on the support forums. A trial account has, at a minimum, the following properties set in the UserRecord: phone number; free trials remaining.

If a user with a trial account has signed up for opt-in marketing (email newsletter), they will be prompted for the following information: email address [required]; first and last name; zip code.

If a non-registered user has signed up to post on the support forums, they will have a trial account with at least the following additional information: email address; display name; and optionally a password.

Note that a trial account normally does not have an associated password. It may have a password, as when a trial account user signs up to post on the support forums. In any case, a trial account may not be used to sign in to the MyxerTones website or wapsite. If a trial account has a password, it may be used to edit the information associated with the account (such as email address, mailing preferences, display name, etc.). If a trial account does not have a password, a user will not be able to access account info or perform any other tasks associated with a registered account, except that they will be able to unsubscribe from the mailing list using an email interface (i.e., mailto:unsubscribe@mvisible.com).

Registered Accounts

A registered account is created through the create a myxer account series of web pages, which may be initiated when the user either (a) selects the ‘Purchase Now’ option from the landing page or login page, or (b) attempts to send a ringtone to their phone through the free trial page when they have already used all free chits. If the phone number specified during the create a myxer account process matches that of a trial user, the same UserRecord will be re-used to create the registered account.

When a registered account is created, it will have the following properties (all of these are required): phone number; password; PIN; display name (for support forums); email address; free trials remaining.

To create a registered account, the user will have had to enter billing information, including credit card/paypal info, billing address, and so forth. While we will not remember that information in our database, Myxer may have a reference to the information in its payment processor so that it can be recalled later.

Registered accounts may be used to sign on to the website and wapsite. If the free trial page is used with a phone number matching a registered account, the free ringtone will be sent if any free trials remain. If they attempt to send a free trial ringtone to their device, and they have already used their free trials, we will redirect them to the login page. Once logged in, the ringtone creation process will continue, giving them the option to buy the ringtone.

Note that while a registered account may obtain its two freebies from the free-trial page, they are not entitled to two free ringtones from the main create page (reached after login).

Registration

To sign up a new user, Myxer requires a mobile phone number. This phone number is sent a text message during the registration process, and the text message contains an activation code that must be entered before the account is created. This prevents people from signing up other people to the service, and then barraging them with SMS messages from our site.

Another way Myxer can protect users from sending messages to other people's phones from Myxer is that we will only send an “activation” message once a day (or some other configurable period). So if a malicious person were trying to send a lot of text messages to another person using the Myxer registration process, we will effectively limit how often they can send to a single person. We have a total maximum number of activation messages we will send to a number as well, currently 10. This means a total of 10 messages may be sent to a given phone number before the phone number is locked out. This type of locking out is implemented by maintaining information in our user database about not just registered users, but the phone numbers that have been specified during the registration process. In a database record keyed by this phone number, we maintain information such as a count of the total number of times we have sent a message to that number, the data and time of the last message sent, and other related information.

Invitations to Myxer

Subscribed users of Myxer can invite other people to the system using either the HTML or WAP interfaces. The invitations may be sent either as email messages (to a ‘normal’ email account, or to an account that is supplied by the carrier and is automatically translated into a text message sent to the phone), or as text messages.

When new users are invited to the system via text messages sent to their phone, they are given a link to a special page on the myxer WAP site. Just by hitting this link, Myxer has the advantage of learning what device they are using and what carrier they are using, using the techniques described elsewhere in this document. If Myxer is unable to detect the device type of the user, or it detects it as an unsupported phone device, it logs an entry in a database that contains a lot of information about the request, including especially the “User-Agent” header passed in the request. Myxer can periodically mine this database to determine which incompatible or unknown phones are hitting the site most frequently, allowing us to focus continued development more efficiently.

For example, if a new device from Nokia were released that Myxer didn't recognize, it would write a record to the database whenever a user with that device followed any link to the WAP site (including an invitation link sent by another user, or an activation link sent as a result of starting the registration process, or any other hit). If the device were popular in the target market, it would receive a large number of hits from this phone, and the records for each hit could be grouped together on the basis of having an identical user-agent string. Periodically, such as at the end of the day or week, the database can be inspected, and the device(s) that have the most records in the database can be targeted for specific development to make them compatible.

In the mobile environment, where the mix of device types is constantly in flux, and it is very difficult to really understand which devices are being used by which demographics, having information about which devices are being directed to a WAP site, especially those that are not recognized or currently supported, is extremely valuable. We don't waste time developing support for devices with a small percentage of the target market, and focus instead on those devices that are actually being used currently.

Note that wherever we say “text message” in this document, we mean one of an SMS message, a WAP Push message, or an MMS message. The types of messages supported by each user's device depends on the device model, the mobile operator with which they are subscribed, and other factors. As we record information about device model, mobile operator, and so forth in our database, we are able to make a determination as to the best (and most cost effective) method for sending messages to a user.

For example, sending SMS messages form the myxer service to a user may cost our company something on the order of 6 to 15 cents per message. The cost varies according to many factors, including the SMS gateway (aggregator) used to send the message, the carrier that the recipient is subscribed with, and so forth. When the user's device can receive messages sent via SMTP email messages, though, the cost to myxer is essentially zero. So when it is possible to get messages to users using SMTP email messages, it is beneficial for us to do so. The real trick is in figuring out whether the recipient supports SMTP email.

To determine the preferred messaging format for a user, we rely on our database of device and carrier capabilities, as well as further information that may be supplied by the user. For example, our database of carrier capabilities contains entries that give information on how to send text messages to subscribers of that carrier via email messages. For example, most T-Mobile customers will receive an SMS message whenever an email is sent to <phonenumber>@tmobile.net. So, a cost effective way of sending a text message to a T-Mobile subscriber with a compatible phone is to send an email to 2025551212@tmobile.net instead of sending an SMS via an SMS gateway. The database contains records that specify rules for carriers, and specify the domain name of email gateways for their subscribers. This database can be updated whenever new information is learned.

Phone and Carrier Detection

Detecting Phone Model

Myxer automatically detects the manufacturer and model of the user's mobile phone. An internal database correlates information provided by the phone's internal WAP or HTML browser software when connecting over a WAP link to known devices. Once the phone model is known, Myxer can determine the capabilities of a device based on information in our database. These capabilities include information such as whether or not the client is a mobile device, file formats supported by the phone for ringtones, limits to ringtone lengths, or message formats supported. When Myxer is extended to support other formats (such as songs or video clips), we can query details about the supported formats for a particular device from our database.

When a device connects to our website, it provides a unique “user agent” string that can be used to identify a particular model of phone and the version of software that is installed. Here a few example user agent strings:

Nokia6600/1.0 (4.09.1) SymbianOS/7.0s Series60/2.0 Profile/MIDP-2.0 Configuration/CLDC-1.0

Samsung-SPHA700 AU-MIC-A700/2.0 MMP/2.0 Profile/MIDP-2.0 Configuration/CLDC-1.1

Mozilla/4.0 (compatible; MSIE 6.0; Windows NT 5.1; SV1; .NET CLR 1.1.4322)

Using the user agent string, Myxer can determine the best ringtone format for a particular device. This data can be gathered from device manufacturers (using UAProf information), public databases, internal testing, and also from Myxer users. Since manufacturers typically base new phones on previous devices, it's possible to predict the capabilities of a device based on previous similar devices released by the manufacturer. By parsing the useragent string, you may be able to find a similar device in the database. Here's a hypothetical example: Nokia releases version 2 of the Nokia 6600, the new user agent string would look something like this: “Nokia6600/2.0 (5.02.1) SymbianOS/7.0s Series60/2.0 Profile/MIDP-2.0 Configuration/CLDC-1.1”, while this might not be in Myxer's database, if it breaks down the useragent string, it would be able to find the entry in the database for the Nokia6600/1.0.

Logging of Unknown Devices

When an unknown device connects to Myxer, it's logged so that we can add the information to our database. We'll also support the ability for users to tell us if the default information we have for their phone is incorrect, so we can continually improve the accuracy of the information in our device database. The process of adding a new device to the database can be automated, using a tool that queries various repositories for device information (include the UAProf profile from the manufacturer) and inserts the information into our database.

Database Entries

The database entry for each phone would look something like this: Useragent (string); Manufacturer (string); Model (string); SupportsRingtones (boolean); PreferredRingtoneFormat (string); RingtoneDownloadLimit (integer); WapPush (boolean); DeviceID (string); BasedOnDevice (string).

For the Nokia 6600, the database entry would be: UserAgent: Nokia6600/1.0 (4.09.1) SymbianOS/7.0s Series60/2.0 Profile/MIDP-2.0 Configuration/CLDC-1.0; Manufacturer: Nokia Model: 6600; SupportsRingtones: true; PreferredRingtoneFormat: awb; RingtoneDownloadLimit: 153600; WapPush: true; DeviceID: Nokia6600-1; BasedOnDevice: NokiaSymbianSeries60.

Detecting Mobile Operator

Myxer automatically detects the company associated with the user's mobile phone. Normally, operators use a Home Location Register (HLR) lookup to determine a phone's mobile operator (based on the phone number). This requires the use of private interfaces that are not exposed to external companies. Myxer detects the mobile operator by examining HTTP variables passed with a request to the Myxer WAP site. One of these identifies the WAP gateway used by the phone to connect to the site.

In general, mobile operators use internal WAP gateways to provide their subscribers with access to internet resources. The IP address of the WAP gateway used by a connecting device is provided with each request to the WAP server. Myxer has a database of known WAP gateways, and associates these with mobile operators. Once an entry for a WAP gateway exists in our database, we are able to determine the operator of which the connecting device is a subscriber.

Typically the domain name of the WAP gateway is a good hint to the user's carrier. If the specific IP address of the WAP gateway is not known, we can use the domain name to determine the carrier. This carrier information is then stored in the user's account record. We can use the carrier information to determine the based why to send an alert to the user's device (either thru an email that is delivered as a text message, sending an alerts to the user thru a modem connect to the carriers network, or determining which SMS gateway provider to use.

In some cases, simply looking at the WAP gateway IP address is insufficient to determine the carrier for the phone being used. In these cases, other HTTP request variables may be used to identify the carrier.

### Content Repurposing

Because different mobile phones support different formats and bitrates for audio files used as ringtones, it is sometimes necessary to translate the format of a source audio file so that it can be properly used on a desired target device. Since Myxer chooses the format after processing the segment, it becomes simple to reformat the segment.

Myxer has a proprietary translation engine that accepts as input audio files in all major audio formats (MP3, M4A, WAV, WMA, etc) along with parameters that identify the desired output file format, encoding bitrate, number of channels, and other information. It decodes the source file into an intermediate representation (which may be simple pulse code modulation (PCM), or may be another intermediate format), and re-encodes the audio into the destination format. The pluggable architecture of this translation engine allows new encoders and decoders to be created that have no knowledge of file formats other than the intermediate format used by the engine.

Because Myxer knows the specific target device for the ringtone, it is able to intelligently convert audio of any supported input format into a format appropriate for that device without any user interaction. The actual encoders/decoders used may be off-the-shelf components, such as those written to work within Windows Media/Microsoft DirectShow.

Intelligent Splicing

Mobile phone ringtones are often short segments of songs. A typical ringtone will be from 15-30 seconds, while a typical popular song might be three and a half to four and a half minutes.

When a user specifies a song that they want to use as a ringtone on their mobile phone, Myxer can automatically choose a short segment of the song to use. This automatic splicing of the song is performed using song identification and a proprietary database containing information about songs and appropriate ringtone segments. Song segment information includes the start and stop points (in milliseconds relative to the beginning of the complete song) to be used for the ringtone. Optionally, fading information can also be included.

A ringtone segment record might therefore have information like: Song: American Idiot; Artist: Green Day; Length: 3:41; Ringtone_Start: 15000; Ringtone_Stop: 35000; FadeIn_Time: 1000; FadeOut_Time: 1000. The preceding record specifies a ringtone based on a segment of the song “American Idiot” by Green Day, the ringtone starting 15 seconds into the song, ending 35 seconds into the song, and having a one second section at the beginning and end of the ringtone during which the audio should be faded in and out, respectively. What constitutes an appropriate ringtone is very subjective, but Myxer makes good choices based on: 1. expert human input, 2. collective input from users, 3. custom algorithms that analyze a song and choose segments based on any of a number of criteria, for example user defined properties, vocal patters, and the like.

Expert Human Input

In this case, Myxer uses a group of people, called ‘ringtone editors’, to define ringtone segments for popular songs. This group of people use a software program that allows them to manually choose segments of songs. For example, they listen to a song, and when a desired “start point” occurs they click a button. Then when the ‘end point’ occurs, they click the button again. They can then preview their selection and modify it by moving the start and end points. When they are satisfied with their selection, they click another button that submits information about the song (i.e., artist, song title, album) along with the start and end points, to the Myxer splice database. (Fading information can also be gathered in a similar fashion). Multiple start and end points can be used, effectively generating multiple segments that are spliced together to create the ringtone. In certain embodiments, the tempo may also be adjusted.

Optionally, an existing audio playback program can be used, and the user can specify the start/stop/fadein/fadeout points manually. These numbers can be entered into the database using something as simple as the SQL Query Analyzer.

Collective User Input

Even when no expert human has suggested a ringtone segment, a ‘layperson’ may choose start and stop points (and fading information) to use. They may use a tool provided by Myxer for that purpose, or they may already have spliced a segment of a song for use as a ringtone using some other means. Myxer has an online ringtone editor that may be used to select the start and stop points. It displays a graphical representation of the uploaded sound file, and lets the user click on the desired start and stop points.

Whenever a user manually chooses start and stop points, Myxer records an entry in the ringtone segment database containing the song, start and stop points, and other associated metadata.

When another user uploads the same song to Myxer, the web interface allows them to preview and/or select segments that were created by other users with the same song. If the user selects the ‘auto-generate’ option, the most popular existing segment will be used. When multiple segments are defined for the same song, Myxer uses a proprietary algorithm to decide the best segment from the choices. This algorithm creates a score for each segment based on the actions of the other users.

One way to do this is to record when a user previews a song segment and record whether or not they then decide to download it to their phone. If they decide in favor of downloading the previewed segment, that action is considered a vote ‘for’ the segment, and an appropriate counter is incremented in the database record containing the segment. If they decide not to download the previewed segment, it is considered a vote ‘against’ the segment, and a different, appropriate counter is incremented in the segment record.

When multiple segments (potential ringtones) exist for a given song, the user may be presented with a choice between more than one of them.

Each song segment is stored in a database. More preferably, metadata about a song and appropriate ringtone segments are stored in the database. Storing just the song metadata. Along with start and end points, a preview count and an accept count are kept for each segment. When a user previews a segment on the web site, the preview count is incremented. If they decide to use the segment to make a ringtone the accept count is incremented. In one embodiment, a user must upload a song or otherwise provide verification of ownership in order to preview a segment generated from that song.

When Myxer is asked to automatically generate a ringtone for a song, it enumerates all of the segments for that song from the database. A score for each segment is generated using a formula that uses both the accept count and the preview count. The segment with the highest score is deemed to be the “best” and is used to create the ringtone. In one embodiment, this formula provides for summation of the positive and negative preview and accept counts, which is stored as metadata about that song segment.

Automated Algorithms

In cases where no expert ringtone editor has chosen an appropriate segment of a song to use as a ringtone, and the user is unable or unwilling to choose splice points themselves, Myxer employs proprietary software algorithms to intelligently choose song segments. These algorithms analyze song files using a wide variety of heuristic information about musical sound. For example, the algorithms can use a technique known as beat-slicing to infer the tempo of a rhythm-based song. For example, kick drums have a unique signature in a sound file that can be easily detected, which is used in modern audio processing equipment to speed up or slow down audio streams without affecting their pitch; the process is called beat-slicing. Information about the tempo, along with additional analysis, may allow the song to be split into segments corresponding to longer sections. As much popular (and especially rock) music uses the familiar “verse-chorus form,” this technique can often detect the points in the song at which verses and instances of the chorus occur. There are many varieties of the “verse-chorus” form, and other forms in popular use today, that may be detected. Regardless of the form of a song, different sections are often easily identified by detectable shifts in amplitude, predominant frequency range, and pattern recognition techniques, as well as a variety of other techniques familiar to audio engineers.

Most of the web pages associated with MyxerTags™ and MyxerTones™ are generated within a modern web server environment such as ASP.NET that allows programmatic processing of all page requests. The ‘code’ for a web page in this context relies to the server-side code-behind associated with processing an HTTP request and generating an appropriate web page. Oftentimes, we make reference to such statements as “The page determines the identity of the calling user.” as short-hand for “the code associated with the HTTP request for a given page determines the identity of the calling user.”

Database Layout for Segment Information

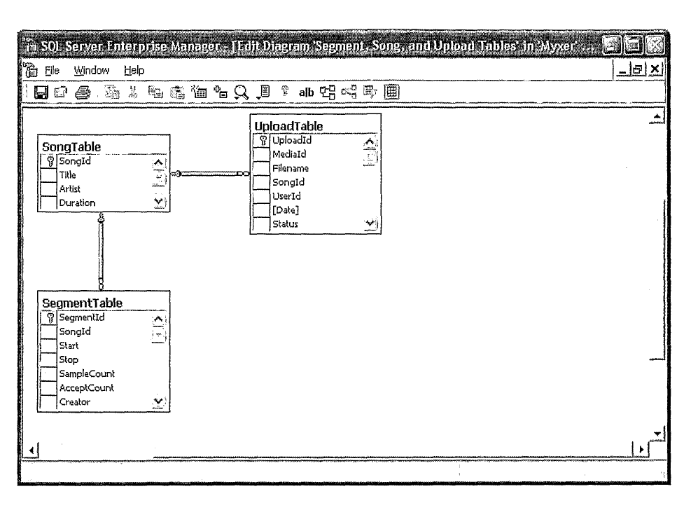

FIG. 2 shows the database tables involved in maintaining the ringtone splice database. Every time a new file is uploaded by a user to be spliced and used as a ringtone, a record is created in the UploadTable. The file is processed by software running on the Myxer server to identify the song it contains. Note that the same song may be encoded in many different ways, and there are many techniques for determining the title, artist, and other properties of a song. Some files (like many MP3's) contain the information in a header, or in another specific part of the file. Sometimes the information is contained in other metadata associated with the file. In some cases, it may be necessary to use a service such as CDDB to identify the song based on a small sample clip of its audio. In any case, each uploaded file is represented by an UploadTable. The song it contains is identified, and the upload record is associated with the song record (in the SongTable) representing that song. If no song record for the identified song already exists, it is created. Song records are unique, in that there will only be a single song record in the SongTable for a given song, regardless of the number of times it has been uploaded by users.

The part of the song to use as a ringtone is identified by a segment record, which is a database record stored in the SegmentTable. The diagram below shows the segment record with a referenced to a SongId (that is, a song record in the SongTable), Start and Stop times that identify the portion of the song specified by the segment, SampleCount and AcceptCount fields used to track the ‘score’ of the segment, and the identity of the user that first created the segment.

Note that other information such as fade-in/fade-out could be specified in a SegmentRecord, and a segment record could otherwise be enhanced to represent a shortened version of a song. For example, it might actually describe two or more distinct sections of the song, along with information on how they should be connected or fused. Because a ringtone segment is often quite short compared to the entire song, a desirable ringtone segment might be one that combines multiple sections of the same song into a compressed form.

### Alternative User Interfaces

Windows Shell Integration

One method of sending a ringtone to a phone using Myxer is to make use of a shell extension that works with operating systems such as Windows XP. This extension is registered so that it displays a new menu item, “Send As Myxer Ringtone”, to all supported file formats. When the user shows the context menu for any supported file, and then selects the Send As Myxer Ringtone menu item, the Myxer Agent begins the process of uploading the specified song, automatically choosing a section to use as a ringtone, and notifying the user's mobile phone. The rest of the process works just as if they had used the web interface to send a ringtone to their phone.

This method of sending a file has the primary advantage of appearing quicker to the user. With the web interface, information about the song (such as artist, song title, album, etc.) can not be detected until the audio file has been completely uploaded to the server. Because the client-side code for shell integration runs on the user's local system, it is able to extract information about the song and send that to Myxer before the full file has finished uploading. If the Myxer service can recommend splice points for the song, and the shell extension code on the local computer is capable of decoding the file format, only the portion of the song necessary for the ringtone need be updated to the server. Thus, the upload time is greatly reduced, and the ringtone appears on the phone faster.

Windows shell integration makes use of a web service interface provided by the Myxer service to communicate with Myxer. This web service interface has function calls such as “SuggestRingtoneSegmentforSong( )” and “SendRingtoneToPhone( )”.

From the foregoing, it is clear that a number of embodiments of the instant invention have been described. Nevertheless, it will be understood that various modifications may be made without departing from the spirit and scope of the claims, which are considered equivalent thereto. For example, the system may be used with various international wireless standards. Accordingly, other embodiments are within the scope of the following claims.

I claim:

1. A ringtone generation system comprising: a WAP interface, a HTML interface and a Web service interface; a database; and one or more media processor components, wherein the system processes audio content input by a user through the media processor to produce an audio file suitable for use as a cellular telephone ringtone.

2. A method of generating a mobile telephone ringtone, comprising: obtaining a computer readable audio file; processing it into a second audio file using the system of claim 1, wherein the second audio file can be processed and played by a mobile telephone; downloading the second audio file to the mobile telephone; and configuring the mobile telephone to play the second audio file as a ringtone.

3. A method of processing an audio file, comprising: obtaining a computer readable audio file; selecting a time interval in the audio file corresponding to a segment of music or voice or both, and processing the audio file into a second audio file that is readable by a mobile telephone and can be configured as a ringtone.

4. The system of claim 1, further comprising: computer readable code that modifies a web page to make all of the web-based content referenced by the webpage available for immediate delivery to a mobile phone.

5. The system of claim 1, further comprising: computer readable code that enables arbitrary internet-hosted media to be located, processed and delivered to mobile phones.

6. A method of editing a media file, comprising: identifying the content of the media file; prompting a first user to select at least one desired portion of the media file; storing data associated with the at least one desired portion of the media file; receiving an inquiry from a second user to obtain an edited version of the media file; and preparing an edited version of the media file for the second user by the use of the data associated with the at least one desired portion of the media file.

7. The method of claim 6, further comprising obtaining information from the second user regarding a desired format of the edited version of the media file.

8. The method of claim 7, wherein the information from the second user regarding a desired format includes details of a mobile phone.

9. The method of claim 6, further comprising verifying ownership rights of the second user in at least a copy of the media file.

10. The method of claim 9, wherein the act of verifying includes the second user transmitting the copy of the media file.

11. The method of claim 9, wherein the act of verifying includes the second user purchasing a copy of the media file.

12. The method of claim 6, wherein the content of the media file is a song.

13. The method of claim 12, wherein the edited version of the media file is a ringtone.

14. The method of claim 13, further comprising transmitting the edited version of the media file to a mobile phone.

15. The method of claim 14, further comprising, before the act of transmitting, receiving a message from the mobile phone.

16. The method of claim 9, wherein the act of transmitting is at least partially by the use of Wireless Application Protocol (WAP).

17. The method of claim 6, wherein the act of identifying involves the use of metadata unique to the content of the media file.

18. The method of claim 6, wherein the act of preparing includes reformatting the edited version of the media file to be able to play as a ringtone on a phone.

19. The method of claim 6, wherein the act of receiving an inquiry includes a message from a mobile phone.

20. The method of claim 6, wherein the act of receiving an inquiry involves the second user entering the request via a web browser.

21. The method of claim 20, wherein the web browser is hosted on a personal computer and the request includes a phone number of the second user.

22. The method of claim 6, wherein the act of prompting includes gathering information concerning portions of the media file not desired by the first user.

23. The method of claim 6, wherein, in the act of prompting, a plurality of users are prompted to select at least one desired portion of the media file and, in the act of preparing, the edited version of the media file is representative of the desired portion of the media file as selected by a majority of the plurality of users.

24. A medium holding electronic device executable steps for a method, the method comprising: identifying the content of the media file by the use of metadata corresponding to the content of the media file; prompting a first user to select at least one desired portion of the media file; storing data associated with the at least one desired portion of the media file; receiving an inquiry from a second user to obtain an edited version of the media file; and preparing an edited version of the media file for the second user by the use of the data associated with the at least one desired portion of the media file, including reformatting the edited version of the media file to be able to play as a ringtone on a phone.

25. A method of editing a media file, comprising: receiving an inquiry from a first user to obtain an edited version of the media file for use as a ringtone on a phone; preparing a first proposed edited version of the media file by the use of beat-slicing to infer the tempo of a rhythm-based song to determine at least one first desired portion of the media file, the first proposed edited version of the media file including the at least one first desired portion; preparing a second proposed edited version of the media file by the use of beat-slicing to infer the tempo of a rhythm-based song to determine at least one second desired portion of the media file, the second proposed edited version of the media file including the at least one second desired portion, the at least one first desired portion of the media file being different from the least one second desired portion of the media file; receiving a preference from the first user between the first proposed edited version and the second proposed edited version; storing the preference from the first user; presenting the preference from the first user to a second user that submits an inquiry to obtain an edited version of the media file for use as a ringtone on a phone.

26. The method of claim 25, wherein the act of receiving an inquiry involves at least one of the group of: an SMS message, a WAP Push message, and an MMS message.

27. A system for editing a media file, the system comprising: a server adapted to store at least one media file and receive preference information concerning at least one desired portion of the media file from a plurality of first users to create an edited version of the media file and receive an inquiry from a second user to obtain an edited version of the media file for use as a ringtone, the inquiry including information regarding the phone on which the ringtone will be used; and a mobile phone in communication with the server to receive the edited version of the media file and audibly play the edited version of the media file upon receiving a call.

28. The system of claim 27, wherein the server is in communication with the mobile phone at least partially by the use of a WAP interface.
